(19) United States
(12) Patent Application Publication
(10) Pub. No.: US 2026/0341957 A1
(43) Pub. Date: Oct. 29, 2026

(54) ANTENNA FOR A VEHICLE

(71) Applicants: HYUNDAI MOTOR COMPANY, Seoul (KR); KIA CORPORATION, Seoul (KR); ACE TECHNOLOGIES CORPORATION, Incheon (KR)

(72) Inventors: Oh Yun Kwon, Hwaseong-si (KR); Je Ok Park, Siheung-si (KR); Sang Pil Kang, Incheon (KR); Jin Kyu Hwang, Incheon (KR)

(73) Assignees: HYUNDAI MOTOR COMPANY, Seoul (KR); KIA CORPORATION, Seoul (KR); ACE TECHNOLOGIES CORPORATION, Incheon (KR)

(21) Appl. No.: 19/376,380

(22) Filed: Oct. 31, 2025

(30) Foreign Application Priority Data
Apr. 23, 2025 (KR) 10-2025-0052860

(51) Int. Cl. H01Q 1/32; H01Q 9/04

(52) U.S. Cl. CPC H01Q 1/3275; H01Q 1/3216; H01Q 9/0421

(57) ABSTRACT

A vehicle antenna includes: a roof garnish configured to form a receiving space on a roof of the vehicle, and an antenna module arranged within the roof garnish. In particular, the antenna module includes: a plurality of antennas each including a conductive body that is integrally and continuously formed by bending to contact at least three surfaces of a carrier having a hexahedral shape. The plurality of antennas is configured to form a resonant frequency by an electric current applied from a power feeding unit, and the power feeding unit is formed in continuation of the conductive body and supplies electric power to a distal end of the conductive body.

### CROSS-REFERENCE TO RELATED APPLICATIONS

This application claims priority to Korean Patent Application Number 10-2025-0052860, filed Apr. 23, 2025, the disclosure of which is incorporated by reference herein in its entirety.

### TECHNICAL FIELD

The present disclosure relates to an antenna for vehicles.

### BACKGROUND

The statements in this section merely provide background information related to the present disclosure and do not necessarily constitute prior art.

To meet the design requirements of vehicles and to secure cost competitiveness, embedded antennas under the roof of a vehicle need to meet the wide bandwidth requirements of 617 to 906 MHz and 1710 to 4200 MHz even in a restrictive environment surrounded by metallic materials.

However, conventional antennas have difficulty in designing to achieve high gain and wide bandwidth due to their complex structure or the use of widely adopted thin patterns. They are also susceptible to performance variation due to the influence of the surrounding environment, and suffer from designing and manufacturing complexity due to multiple tuning points.

Furthermore, existing antennas technologies are limited by requirements to equally satisfy watertightness and miniaturization.

### SUMMARY

According to at least one embodiment of the present disclosure, a vehicle antenna for a vehicle includes: a roof garnish configured to form a predetermined receiving space on a roof on a rear rail side of the vehicle, and an antenna module disposed within the roof garnish. The antenna module includes a plurality of antennas each including a conductive body integrally and continuously formed by bending to be in contact with at least three surfaces of a carrier having a hexahedral shape. The plurality of antennas is configured to form a resonant frequency by an electric current applied from a power feeding unit. The power feeding unit is formed in continuation of the conductive body and supplies electric current to a distal end of the conductive body.

### BRIEF DESCRIPTION OF THE DRAWINGS

FIG. 1 is a diagram illustrating the position of an antenna for a vehicle, according to at least one embodiment of the present disclosure.

FIG. 2 is a perspective view of an antenna module arranged in a roof garnish, according to at least one embodiment of the present disclosure.

FIG. 3 is a perspective view of a conductive body of an antenna module according to at least one embodiment of the present disclosure.

FIG. 4 is an unfolded (developed) view of the conductive body according to at least one embodiment of the present disclosure.

FIG. 5 is a perspective view of a conductive body according to a first embodiment of the present disclosure.

FIG. 6 is a perspective view of a conductive body in an unfolded state according to a second embodiment of the present disclosure.

FIG. 7 is a perspective view of a conductive body according to a third embodiment of the present disclosure.

The drawings described herein are for illustration purposes only and are not intended to limit the scope of the present disclosure in any way.

### DETAILED DESCRIPTION

The present disclosure provides a monopole antenna structure that is disposed within a vehicle and satisfies 5 G sub-6 specifications for low-, mid-, and high-bandwidths.

Furthermore, embodiments of the present disclosure provide conductive body that is formed based on any one of a planar inverted-f antenna (PIFA) structure, a planar structure, and a round structure, thereby facilitating antenna installation and placement according to various geometries of the interior or exterior of the vehicle.

The objects of the present disclosure are not limited to those particularly described hereinabove, and the above and other objects that the present disclosure can achieve should be clearly understood by those having ordinary skill in the art from the following detailed description.

Hereinafter, some embodiments of the present disclosure are described in detail with reference to the accompanying drawings. In the following description, like reference numerals preferably designate like elements, although the elements are shown in different drawings. Further, in the following description of some embodiments, a detailed description of known related components and functions is omitted for the purpose of clarity and brevity when such description would obscure the subject of the present disclosure.

Various ordinal numbers or alpha codes, such as first, second, i), ii), a), b), etc., are prefixed to describe the components of embodiments of the present disclosure. In addition, unless explicitly described to the contrary, the term “comprise” and variations thereof, such as “comprises” or “comprising”, should be understood to imply the inclusion of stated elements but not the exclusion of any other elements. The same understanding should apply to similar terms such as “have,” “include”, and the like.

When components are described as ‘connected’, ‘coupled’, or ‘linked’ to another component, they are meant to not only directly ‘connected’, ‘coupled’, or ‘linked’ but also to indirectly ‘connected’, ‘coupled’, or ‘linked’ via one or more additional components.

The terms such as ‘unit’, ‘module’, and the like refer to units for processing at least one function or operation, which may be implemented by hardware, software, or a combination thereof. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Unless the contrary is indicated, the description of any one of embodiments is intended to apply to other embodiments.

The description of the present disclosure to be presented below in conjunction with the accompanying drawings is intended to describe exemplary embodiments of the present disclosure and is not intended to represent the only embodiments in which the technical idea of the present disclosure may be practiced.

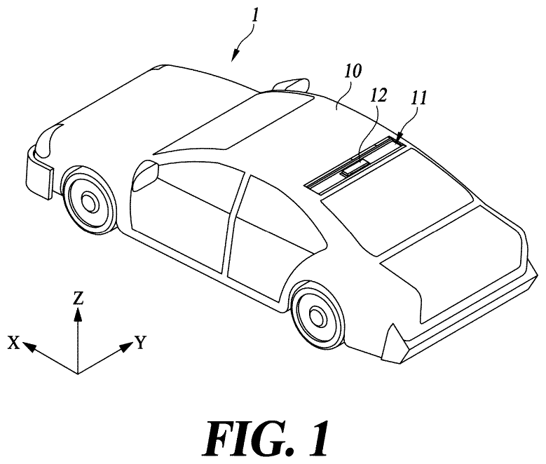

FIG. 1 is a diagram illustrating the position of an antenna for a vehicle 1, according to at least one embodiment of the present disclosure.

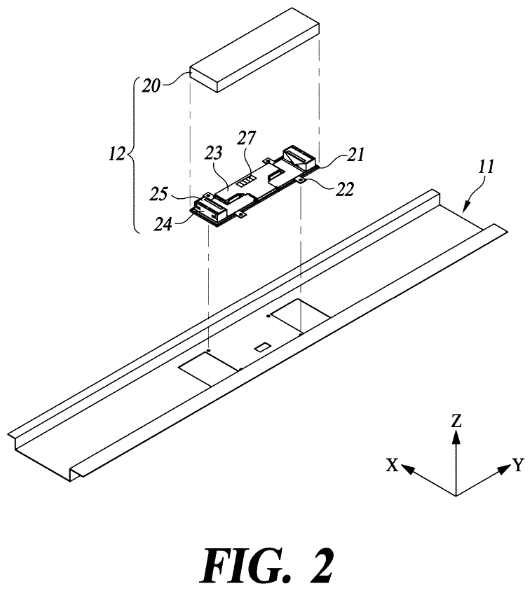

FIG. 2 is a perspective view of an antenna module 12 disposed within a roof garnish, according to at least one embodiment of the present disclosure.

Referring to FIGS. 1 and 2, according to at least one embodiment of the present disclosure, the antenna module 12 may be disposed within a roof garnish 11 of the vehicle 1. Here, the roof garnish 11 forms a predetermined receiving space on the roof, on the rear rail side of the vehicle 1. However, the location of the roof garnish 11 is not limited to this example. The roof garnish 11 may be located at any position on a roof panel 10 of the vehicle 1.

According to at least one embodiment, the antenna module 12 is configured as an embedded type, positioned beneath (e.g., at the bottom of) the roof panel 10 of the vehicle 1, rather than an external type mounted on the top of the roof panel 10. According to at least one embodiment, the antenna module 12 is implemented as a structure that is mounted on top of a metallic rear rail.

The antenna module 12 of the vehicle 1 may be disposed within the roof garnish 11. The antenna module 12 may be fixed to the center region of the roof garnish 11 by using a bracket. Multiples brackets are provided in a quantity corresponding to the number of holes formed in the roof garnish 11. For example, a bracket is provided for each hole formed in the roof garnish 11. The brackets are fixed to the roof garnish 11 by screws and bolts.

The antenna module 12 includes an upper cover 20 and a lower cover 21. The upper cover 20 and lower cover 21 may enclose a plurality of antennas 27, a printed circuit board 23, and others.

The antenna module 12, according to at least one embodiment, implements a wide-bandwidth specification. For example, the antenna module 12 may implement specifications for both a 617-to-960 MHz bandwidth and a 1710-to-4200 MHz bandwidth.

The antenna module 12, according to at least one embodiment, includes a plurality of cellular communication system antennas (CCS antennas). The antenna module 12 may include a global navigation satellite system antenna (GNSS antenna).

The GNSS antenna includes a Sirius-XM (SXM) patch antenna. The SXM patch antenna receives a satellite broadcast (SDARS) signal, and the received signal is processed through a low noise amplifier (LNA) and filters. The processed SXM signal is powered through a bias tee and transmitted to an infotainment unit (not shown).

The GNSS antenna may be disposed in the center area of the printed circuit board 23 on the antenna module 12. Multiple CCS antennas may be disposed at positions that are symmetrical in the longitudinal direction relative to the GNSS antenna, which is disposed in the center region of the printed circuit board 23.

The multiple CCS antennas, according to at least one embodiment, each include a conductive body 25 disposed on carriers 24 formed in a hexahedral shape. The multiple CCS antennas may be disposed on the carriers 24 at opposite ends of the antenna module 12, in positions that are longitudinally opposite. The carrier 24 may be formed in a cubic or cuboid shape but is not necessarily limited thereto.

The multiple CCS antennas are connected with the printed circuit board 23. The printed circuit board 23 may provide power to the multiple CCS antennas. For example, the printed circuit board 23 may supply power to the multiple CCS antennas by a DC bias source. The printed circuit board 23 may supply power via RF signal lines or may include a separate power line.

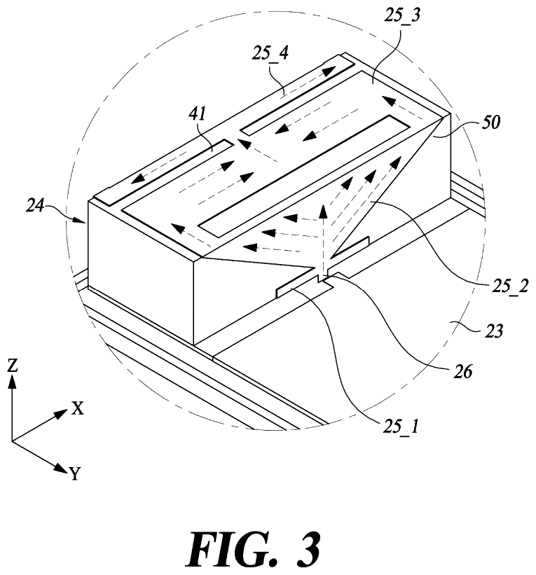

FIG. 3 is a perspective view of the conductive body 25 of an antenna module according to at least one embodiment of the present disclosure.

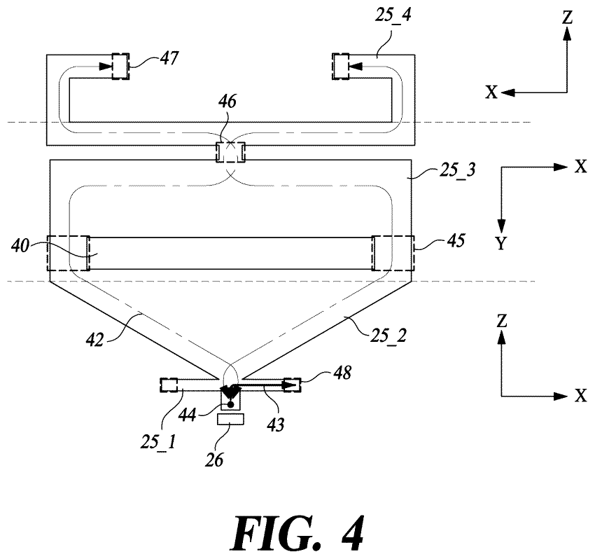

FIG. 4 is a developed view of the conductive body 25 according to at least one embodiment of the present disclosure.

FIG. 3 illustrates the conductive body 25 being bent and disposed on a first side surface, a top surface, and an opposite second side surface of the carrier 24.

FIG. 4 illustrates, in a single plane, a first conductive member 25_1 and a second conductive member 25_2 configured to be disposed on the first side surface of the carrier 24, a third conductive member 25_3 configured to be disposed on the top surface of the carrier 24, and a fourth conductive member 25_4 configured to be disposed on the second side surface opposite to the first side surface of the carrier 24. In FIG. 4, imaginary dashed lines illustrate bending portions of the conductive body 25 according to at least one embodiment of the present disclosure. Therefore, in the following description of the conductive body 25 based on FIG. 4, the first conductive member 25_1 through the fourth conductive member 25_4 are supposed to be disposed on different sides of the carrier 24, not in the same plane.

Referring to FIGS. 1 to 4, the conductive body 25, according to at least one embodiment of the present disclosure, includes the first conductive member 25_1, second conductive member 25_2, third conductive member 25_3, and fourth conductive member 25_4.

The conductive body 25, according to at least one embodiment, forms a primary radiator of a 5 G Sub-6 band. As used herein, 5 G Sub-6 band refers to a 5G communication band that utilizes frequencies below 6 GHz, for example.

According to at least one embodiment, the first conductive member 25_1 through the fourth conductive member 25_4 are integrally formed in a back-to-back arrangement. The first conductive member 25_1 through the fourth conductive member 25_4 are supplied with current from a power feeding unit 26 to form a resonant frequency.

The conductive body 25, according to at least one embodiment, has a bent shape to contact at least three sides of the carrier 24. The carrier 24 is configured to support the conductive body 25. The carrier 24 isolates the conductive body 25 from a wireless communication terminal's main board by a certain spacing for allowing the conductive body 25 to exhibit desired radiation characteristics.

The first conductive member 25_1, according to at least one embodiment, is located adjacent to the power feeding unit 26. The first conductive member 25_1 is capable of adjusting an inductance component along its length corresponding to the x-axis direction. In other words, the inductance associated with the first conductive member 25_1 can be adjusted by changing its length along the x-axis direction.

The bandwidth of the first conductive member 25_1 according to at least one embodiment may implement a performance in a frequency band of 3300 to 4200 MHz. In particular, the first conductive member 25_1 constitutes a primary radiator in the 5 G Sub-6 band.

The first conductive member 25_1 shifts the current supplied from the power feeding unit 26 by a distance based on a second current path 43 to achieve frequency resonance. Here, the second current path 43 refers to the current path extending from an imaginary first point 44 adjacent to the power feeding unit 26 to fourth regions 48, which are located at opposite ends of the first conductive member 25_1. For example, the second current path 43 may be increased or decreased by adjusting the length of the first conductive member 25_1 in the x-axis direction and the negative (−) x-axis direction thereof. This adjustment has the same effect as adjusting the inductance component as described above.

The first conductive member 25_1 forms a coupling with the second conductive member 25_2, as described below. The coupling between the first conductive member 25_1 and the second conductive member 25_2 varies based on the relative placement of the first conductive member 25_1 and the second conductive member 25_2. By shifting the position of the first conductive member 25_1 in the z-axis direction, the coupling between the first conductive member 25_1 and the second conductive member 25_2 may be adjusted to optimize signal sharing between the multiple CCS antennas.

By adjusting the relative placement of the first conductive member 25_1 in relation to the second conductive member 25_2, adjusting its length, and altering its pattern, the first conductive member 25_1 according to at least one embodiment may have its capacitance adjusted and its bandwidth extended.

According to another embodiment, the first conductive member 25_1 may have its pattern shape partially bent in the x-axis direction and the negative (−) x-axis direction. This may increase the length of the second current path 43, leading to an increased capacitance and an extended bandwidth.

According to at least one embodiment, the second conductive member 25_2 is formed in continuation of the first conductive member 25_1. The second conductive member 25_2 is formed in a conical shape that gradually widens in the z-axis direction from the imaginary first point 44 on the power feeding unit 26.

The second conductive member 25_2 has a longer wavelength than the first conductive member 25_1 and may be configured to operate in a frequency band of, for example, 3000 MHz.

In another embodiment, the second conductive member 25_2 may vary the opening angle of its conical shape to increase the performance of the impedance matching. For example, increasing the opening angle of the second conductive member 25_2 may result in a lower characteristic impedance and higher broadband characteristics. Conversely, decreasing the opening angle of the second conductive member 25_2 may result in a more gradual change in impedance, allowing for effective matching.

The first conductive member 25_1 and the second conductive member 25_2 may be disposed adjacent to one side surface of the carrier 24.

The third conductive member 25_3, according to at least one embodiment, is formed in continuation of the second conductive member 25_2. The third conductive member 25_3 is bent along a line where the second conductive member 25_2 is in line contact with the first side surface and the top surface of the carrier 24. The third conductive member 25_3, according to at least one embodiment, is disposed on the top surface of the carrier 24.

The third conductive member 25_3 includes: at least one or more slots 40, and at least one or more slits 41 having a rectangular shape.

The third conductive member 25_3 may implement a low-bandwidth strong capacitance by the formation of the slots 40, and a mid-bandwidth strong capacitance by the formation of the slits 41.

For example, the present disclosure may adjust the distance in the y-axis direction between the slot 40 and the slit 41 on the third conductive member 25_3. It is to place the slot 40 and the slit 41 on the third conductive member 25_3 at positions that do not cause current interference between the slot 40 and the slit 41.

The slot 40 and the slit 41 may implement, on the third conductive member 25_3, first current paths 42 that conduct current delivered from the second conductive member 25_2 in multiple directions. Specifically, the current supplied from the power feeding unit 26 may flow through the imaginary first point 44 formed adjacent to the power feeding unit 26 to reach first regions 45 formed on both sides of the slot 40 in the x-axis direction. The current conducting from the first point 44 to the first regions 45 may define various current paths based on the conical shape of the second conductive member 25_2. The current along the first current paths 42 is transmitted via the first regions 45 to a second region 46. Here, the current on the third conductive member 25_3 travels along optimal paths generated from the slot 40 and the slits 41.

The second conductive member 25_2 and the third conductive member 25_3, according to at least one embodiment, constitute a mid- and high-bandwidth primary radiator.

The mid-bandwidth (1710 MHz to 2690 MHz) requires a wide bandwidth, which makes it important to secure stable performance over a wider frequency range when designing an antenna. The antenna's current flow in a single direction may improve the gain at a certain frequency; however, this entails a limitation of a reduced bandwidth. A solution is to form the slot 40 and slits 41 in the third conductive member 25_3 to change the current flow and generate additional capacitance through slots 40, thereby achieving a bandwidth expansion.

In particular, the slot 40 and slits 41 of the third conductive member 25_3 form a capacitance and serve as radiators at low-bandwidth and mid-bandwidth. These slot 40 and slits 41 are configured to be on the top surface of the carrier 24, which is an optimized location for antenna radiation, allowing for effective radiation at mid- and high-bandwidths.

If the slots 40 are removed from the third conductive member 25_3, the current flow that generates the mid- and high-bandwidth resonances becomes simplified, and the first current paths 42 are relatively shortened, thereby shifting the overall resonant frequency of the antenna upward. This results in poor performance in the mid-bandwidth, and although strong radiation gain could be obtained at certain frequencies, the overall bandwidth is undesirably narrowed.

Therefore, by forming the slot 40 and the slits 41 on the widest side, i.e., the top side, of the conductive body 25, the broadband characteristics of the antenna can be secured, and their radiator functionality in the mid- and high-bandwidth can be optimized.

The third conductive member 25_3, according to another embodiment, may change the flow of current by moving the position of the slot 40 in the y-axis direction or in the negative (−) y-axis direction, or by changing the size of the slot 40. Changing the flow of current can achieve resonance and impedance matching. This allows the impedance to be matched with the power feeding unit 26 to minimize reflection loss. Therefore, by varying the position and size of the slot 40, the flow of the first current paths 42 may be regulated to induce or suppress resonance at certain frequencies, while regulating the impedance to optimize power transfer efficiency.

The fourth conductive member 25_4, according to at least one embodiment, forms a low-bandwidth primary radiator.

For example, the fourth conductive member 25_4 may constitute the primary radiator in the band 617 to 960 MHz.

The conductive body 25, according to at least one embodiment, needs to have a longer current flow to effectively resonate low-bandwidth frequencies within a limited volume. To this end, the fourth conductive member 25_4 is configured to have an ‘L’ shape that is easily modified to narrow the width and optimize the length.

The fourth conductive member 25_4 is formed with some bends to extend the current paths to the distal end points at third regions 47 from the second region 46 which is a point continuous with the third conductive member 25_3. Specifically, the fourth conductive member 25_4 has a bent shape to provide an optimized current path from the second region 46 of the third conductive member 25_3 to the third region 47 of the fourth conductive member 25_4 when the current passing through the second region 46 reaches the third region 47. As used herein, an optimized current path refers to a current path that ensures a longer flow of current within a limited volume.

For example, the third region 47, which is the distal end of the fourth conductive member 25_4, may have the most concentrated flow of current and have a limited height in the z-axis direction on the second side surface of the carrier 24. For example, antenna gain may be degraded as the third region 47 gets closer to the printed circuit board 23. When the third region 47 is located adjacent to the printed circuit board 23, the electromagnetic waves radiated from the fourth conductive member 25_4 increase the surface waves propagating along the printed circuit board 23. The increased surface waves cause losses inside and outside the printed circuit board 23, and may reduce the overall antenna efficiency. In addition, if the fourth conductive member 25_4 is located adjacent to the printed circuit board 23, it may be coupled to the ground plane, which may reduce radiation efficiency.

Furthermore, if the third region 47 is too far away from the printed circuit board 23, currents in different directions on the fourth conductive member 25_4 may cancel each other out and degrade the gain of the antenna. The canceling action between the currents flowing in opposite directions may cause a decrease in the gain, distortion in the radiation pattern, and instability in the resonance frequency and impedance characteristics.

Accordingly, the position of the fourth conductive member 25_4 on the second side surface of the carrier 24 may be arranged to resonate at the required frequency over a low-bandwidth.

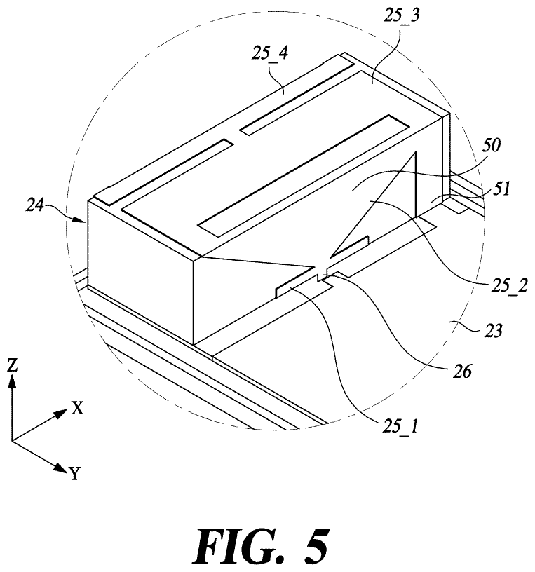

FIG. 5 is a perspective view of the conductive body 25 according to a first embodiment of the present disclosure.

Referring to FIGS. 1, 3, and 5, the conductive body 25, according to the first embodiment of the present disclosure, is formed based on a Planar Inverted-F Antenna (PIFA) structure.

Due to the structural characteristics of the vehicle 1, the environment in which the antenna module 12 is located is not constant, and depending on the surface of the roof panel 10 on which the antenna module 12 is installed, difficulties may occur such as resonance frequency fluctuations, increased reflection loss, and the like. The conductive body 25, according to the first embodiment, includes the first conductive member 25_1, second conductive member 25_2, third conductive member 25_3, and fourth conductive member 25_4, and a shorting pin 51 connected with a ground plane 50 may be added to form the PIFA structure.

Connecting the conductive body 25 to the ground plane 50 by the shorting pin can reduce the impedance fluctuations due to changes in the environment surrounding the vehicle 1 and implement stable power transfer characteristics. In particular, such connection can reduce electromagnetic interference generated by surrounding structures made of metallic materials inside the vehicle 1, thereby optimizing the antenna performance.

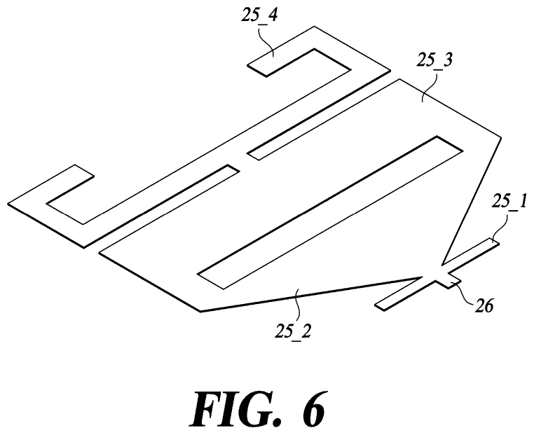

FIG. 6 is a perspective view of the conductive body 25 in an unfolded state, according to a second embodiment of the present disclosure.

Referring to FIGS. 3 and 6, the conductive body 25 according to the second embodiment is configured as a planar type.

The conductive body 25, according to the second embodiment, is assembled by press on the top surface of the carrier 24, which is formed as a rectangle. However, the present disclosure is not so limited, and the conductive body 25 according to the second embodiment may be otherwise attached to the top surface of the upper cover 20.

The conductive body 25 may use as its basis the printed circuit board 23 that is flexible. In this case, they can be attached to the vehicle 1 in an optimal position to fit the internal and external structure of the vehicle 1. Utilizing the flexible printed circuit board 23 has the effect of providing flexibility in antenna installation and not being limited by space within the vehicle 1.

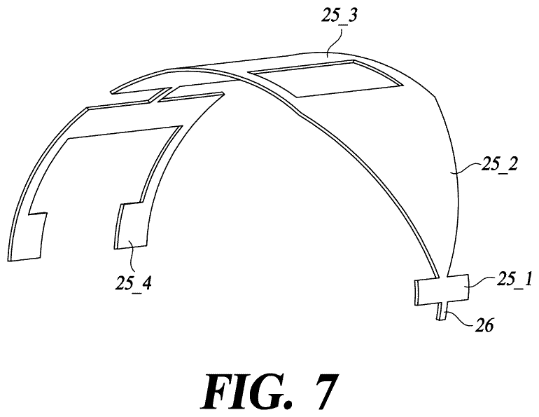

FIG. 7 is a perspective view of conductive body 25 according to a third embodiment of the present disclosure.

Referring to FIGS. 3 and 7, the conductive body 25 according to the third embodiment is formed based on a round structure.

The conductive body 25, according to the third embodiment, can be effectively applied to an affixing surface having a curvature on the inside or outside of the vehicle 1.

When the conductive body 25 is mounted on the printed circuit board 23 or the carrier 24 that is square-shaped, the installation environment may be limited given the design constraints of the vehicle 1 or electronic devices. In particular, mounting a planar antenna on a curved affixing surface such as a garnish, pillar, roof, etc. of the vehicle 1. In this respect, the conductive body 25 can be adaptively structured with a curvature to be securely attached and used even on an affixing surface having a curved surface.

According to at least one embodiment, the antenna for a vehicle is located inside the vehicle and is capable of providing a monopole antenna structure that satisfies the 5 G sub-6 specifications of low-, mid-, and high-bandwidths.

In another embodiment, the antenna for a vehicle is formed based on any one of the PIFA structure, the planar structure, and the round structure, which has the effect of facilitating the antenna installation and placement according to various geometries of the interior or exterior of the vehicle.

Although embodiments of the present disclosure have been described for illustrative purposes, those having ordinary skill in the art should appreciate that various modifications, additions, and substitutions are possible without departing from the idea and scope of the present disclosure. Therefore, the embodiments of the present disclosure have been described for the sake of brevity and clarity. The scope of the technical idea of the embodiments of the present disclosure is not limited by the illustrations. Accordingly, one of ordinary skill would understand that the scope of the present disclosure is not to be limited by the above explicitly described embodiments but by the claims and equivalents thereof.

### REFERENCE NUMERALS

1: vehicle 10: roof panel
11: roof garnish 12: antenna module
20: upper cover 21: lower cover
22: bracket 23: printed circuit board
24: carrier 25: conductive body
25_1: first conductive member 25_2: second conductive member
25_3: third conductive member 25_4: fourth conductive member
26: power feeding unit 27: plurality of antennas
40: slot
41: slit 42: first current path
43: second current path 44: first point
45: first region 46: second region
47: third region 48: fourth region
50: ground 51: shorting pin

What is claimed is:

1. A vehicle antenna for a vehicle, comprising:
a roof garnish configured to form a predetermined receiving space on a roof of the vehicle; and
an antenna module disposed within the predetermined receiving space of the roof garnish,
wherein the antenna module comprises a plurality of antennas each comprising a conductive body integrally and continuously formed by bending to contact at least three surfaces of a carrier having a hexahedral shape, and
wherein the plurality of antennas is configured to form a resonant frequency by an electric current applied from a power feeding unit, and the power feeding unit is formed in continuation of the conductive body and configured to supply the electric current to a distal end of the conductive body.

2. The vehicle antenna of claim 1, wherein the plurality of antennas are disposed in positions symmetrical to each other in a longitudinal direction of the antenna module.

3. The vehicle antenna of claim 1, wherein the conductive body comprises:
a first conductive member disposed adjacent to the power feeding unit and configured to regulate an inductance component based on a length of the first conductive member;
a second conductive member formed in continuation of the first conductive member and having a conical shape that widens from a point on the power feeding unit;
a third conductive member formed in continuation of the second conductive member and comprising at least one slot and at least one slit; and
a fourth conductive member formed in continuation of the third conductive member and having a predetermined length and a predetermined width.

4. The vehicle antenna of claim 3, wherein the conductive body is formed in accordance with one of a Planar Inverted-F Antenna (PIFA) structure, a round structure, or a planar structure.

5. The vehicle antenna of claim 4, wherein the PIFA structure comprises
a shorting pin configured to be connected to a ground plane.

6. The vehicle antenna of claim 4, wherein the round structure is formed with a predetermined curvature extending from the power feeding unit to the distal end of the conductive body.

7. The vehicle antenna of claim 4, wherein the planar structure comprises:
a single plane formed by the first conductive member, the second conductive member, the third conductive member, and the fourth conductive member.

8. The vehicle antenna of claim 3, wherein the conductive body comprises:
a first current path extending from the power feeding unit to a distal end of the fourth conductive member; and
a second current path extending from the power feeding unit to a distal end of the first conductive member.

9. The vehicle antenna of claim 8, wherein the first current path comprises:
a path configured to conduct current:
from an imaginary first point located in the power feeding unit, through one of imaginary first regions positioned at outer positions of the at least one slot of the third conductive member, and through an imaginary second region at a position where the third conductive member and the fourth conductive member are connected, to reach one of imaginary third regions located at the distal end of the fourth conductive member.

10. The vehicle antenna of claim 8, wherein the second current path comprises:
a path configured to conduct current from an imaginary first point located in the power feeding unit to reach an imaginary fourth region located at the distal end of the first conductive member.

11. The vehicle antenna of claim 3, wherein the second conductive member is configured to establish a coupling in an intervening region defined by a space between the second conductive member and the first conductive member.

12. The vehicle antenna of claim 3, wherein the third conductive member is configured to control a flow of current in a plurality of directions conducting from the second conductive member to the fourth conductive member, based on a size of the at least one slot and a size of the at least one slit.

13. The vehicle antenna of claim 3, wherein the fourth conductive member is bent to into an ‘L’ shape to define an extended current path extending from a point continuous with the third conductive member to a distal end.
